(19) United States
(12) Patent Application Publication
(10) Pub. No.: US 2024/0221115 A1
(43) Pub. Date: Jul. 4, 2024

(54) ULTRA-HIGH RESOLUTION CT RECONSTRUCTION USING GRADIENT GUIDANCE

(71) Applicant: Subtle Medical, Inc., Menlo Park, CA (US)

(72) Inventor: Lei XIANG, Shanghai (CN)

(21) Appl. No.: 18/607,804

(22) Filed: Mar. 18, 2024

Related U.S. Application Data
(63) Continuation of application No. PCT/CN2022/120184, filed on Sep. 21, 2022.

(30) Foreign Application Priority Data
Sep. 30, 2021 (WO) PCT/CN2021/122318

(51) Int. Cl. G06T 3/4053; G06T 3/4046; G06T 11/00

(52) U.S. Cl. CPC G06T 3/4053; G06T 3/4046; G06T 11/006; G06T 2210/41; G06T 2211/441

(57) ABSTRACT

A computer-implemented method is provided for ultra-high resolution computed tomography. The method comprises: acquiring, using computed tomography (CT), a medical image of a subject, the medical image has a lower resolution; and processing the medical image, with aid of a deep learning network model, to reconstruct an ultra-high resolution medical image, where the deep learning network model is trained using a generative adversarial network (GAN)-based framework with a gradient guidance.

### CROSS-REFERENCE TO RELATED APPLICATION

This application is a continuation of PCT International Application No. PCT/CN2022/120184 filed Sep. 21, 2022, which claims priority to PCT International Application No. PCT/CN2021/122318 filed on Sep. 30, 2021, the content of which is incorporated herein in its entirety.

### BACKGROUND

Computed tomography (CT) is one of the most widely used medical imaging modality. For example, CT imaging can be used for detection of various diseases such as pulmonary diseases, COVID-19 and various others. Over the last few decades, CT imaging is generating considerable interest in terms of improving the spatial resolution for more accurate diagnosis. However, those hardware-oriented methods for improving resolution always come with increased scanning time and radiation dose, which might lead to genetic damage and cancer.

### SUMMARY

Ultra-high resolution computed tomography (UHRCT) has shown great potential for detection of disease such as pulmonary diseases, or COVID-19 due to the enhancement of radiomic features. However, high resolution scanning generally induces increases in scan time and radiation dose. While recent studies have shown deep learning based image super-resolution methods might provide higher quality in anatomical details as compared to conventional CT, the performance is not good enough for use in real clinical settings.

Current methods may attempt to improve the image resolution for CT using deep learning based super-resolution (SR) algorithms on natural images. For example, one method involves a single-slice CT SR network and a multi-slice CT SR network using skip connection and residual learning to generate high-frequency textures (e.g., more detailed features). One method used a U-shaped network architecture to learn an end-to-end mapping between thick-slice CT images and thin-slice CT images. One method incorporated the ideas from cycle-generative adversarial network (GAN) and proposed a GAN-based semi-supervised framework with various objective functions to achieve 2× single-slice CT SR. One method involves a sinogram super-resolution generative adversarial network (SSR-GAN) model with cycle consistency loss, sinogram domain loss, and reconstruction image domain loss to realize CT super-resolution in sinogram space. Another method adopted Residual Whole Map Attention Network (RWMAN) as generator to develop a deep learning-based method MedSRGAN for SR in medical imaging, where a weighted sum of content loss, adversarial loss, and adversarial feature loss were fused together.

However, the aforementioned methods and current methods mainly focus on processing simulation images or phantom data (synthetic datasets generated for training or testing with known truth such as the fine detailed features), and require the image pairs ideally matching in spatial location.

The present disclosure provides an improved CT super-resolution method based on relativistic generative adversarial network (GAN) with gradient guidance. Unlike the conventional methods requiring simulated or phantom image pairs to simulate different scenarios, the CT super-resolution method and system herein may beneficially allow for direct learning of the mapping based on clinical data pairs (original image data) and reconstructing reliable ultra-high resolution CT (UHRCT) images.

In some embodiments, the provided framework may use gradient maps as side information to recover more perceptual-pleasant details. In some cases, the systems and methods may generate predicted gradient maps of high-resolution CT using additional gradient branch to assist the super resolution (SR) reconstruction task. In some cases, systems and methods herein may directly restrict the gradient maps of the predicted SR images. In some embodiments, the methods may avoid fake details generated by generative adversarial network (GAN) by using L₁ loss and perceptual loss. Experimental results show that the methods herein can be directly applied to the real clinical settings and outperforms other state-of-the-art methods that focus on the simulated scenarios.

The present disclosure provides a GAN-based framework with gradient guidance branch for Ultra-High Resolution CT and the GAN-based framework is suitable for clinical use. By adjusting the weights of adversarial loss, perceptual loss, pixel-wise loss and gradient loss, as well as applying the guidance of gradient branch, the framework can directly learn the mapping from original data pairs (e.g., clinical data pairs) and reconstruct reliable UHRCT images. Experimental results show that the proposed method outperforms other state-of-art CT SR frameworks (quantified by peak signal-to-noise ratio (PSNR) and structural index similarity (SSIM)) and achieves fine anatomical structures.

In an aspect, a computer-implemented method is provided for ultra-high resolution computed tomography. The method comprises: (a) acquiring, using computed tomography (CT), a medical image of a subject, where the medical image has a lower resolution; and (b) processing the medical image, with aid of a deep learning network model, to reconstruct an ultra-high resolution medical image, where the deep learning network model is trained using a generative adversarial network (GAN)-based framework with a gradient guidance.

In a related yet separate aspect, a non-transitory computer-readable storage medium including instructions that, when executed by one or more processors, cause the one or more processors to perform operations. The operations comprise: (a) acquiring, using computed tomography (CT), a medical image of a subject, where the medical image has a lower resolution; and (b) processing the medical image, with aid of a deep learning network model, to reconstruct an ultra-high resolution medical image, where the deep learning network model is trained using a generative adversarial network (GAN)-based framework with a gradient guidance.

In some embodiments, the GAN-based framework comprises a first branch for improving a resolution of a medical image, and a second branch for generating a predicted gradient map. In some cases, the predicted gradient map is used to guide the training of the first branch. In some instances, the predicted gradient map is concatenated with a feature map of the first branch and is supplied to a residual block. In some cases, the second branch uses a pixel-wise loss in a training process. In some cases, the first branch uses a combination of pixel-wise loss and a GAN loss in a training process.

In some cases, the second branch incorporates one or more intermediate feature maps generated by the first branch. In some instances, the first branch comprises a set of residual blocks and the one or more intermediate feature maps are generated by one or more residual blocks selected from the set of residual blocks. In some cases, the first branch comprises a first set of residual blocks and wherein the second branch comprises a second set of residual blocks. In some cases, an input to the second branch includes a gradient map of the medical image acquired in (a).

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and descriptions are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a gradient-guided GAN framework for Ultra-high super-resolution CT.

FIG. 2 illustrates visual comparison of results by different training strategies.

FIG. 3 illustrates qualitative comparison of the method with other state-of-the-art methods.

FIG. 4 shows visualization of gradient map.

FIG. 5 schematically illustrates an example of a system implementing the methods herein.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As mentioned above, conventional methods may focus on simulated or phantom image pairs to simulate different scenarios thereby training a model to improve the image resolution for CT. Such methods require ideal matching of image pairs which can result in poor performance due to misalignment of the image pairs.

In aspect, the present disclosure provides an improved CT super-resolution method based on relativistic generative adversarial network (GAN) with gradient guidance. Unlike the conventional methods requiring simulated or phantom image pairs, the CT super-resolution method and system herein may beneficially allow for direct learning of the mapping based on clinical data pairs (original image data) and reconstructing reliable ultra-high resolution CT (UHRCT) images.

In some embodiments, the provided framework may use gradient maps as side information to recover more perceptual-pleasant details. In some cases, the systems and methods may generate predicted gradient maps of high-resolution CT using additional gradient branch to assist the super resolution (SR) reconstruction task. In some cases, systems and methods herein may directly restrict the gradient maps of the predicted SR images. In some embodiments, the methods may avoid fake details generated by generative adversarial network (GAN) by using L₁ loss and perceptual loss. Experimental results show that the methods herein can be directly applied to the real clinical settings and outperforms other state-of-the-art methods that focus on the simulated scenarios.

The present disclosure provides a GAN-based framework with gradient guidance branch for Ultra-High Resolution CT and the GAN-based framework is suitable for clinical use. In some cases, by adjusting the weights of adversarial loss, perceptual loss, pixel-wise loss and gradient loss, and/or applying the guidance of gradient branch, the framework can directly learn the mapping from original data pairs (e.g., clinical data pairs) and reconstruct reliable UHRCT images. Experimental results show that the proposed method outperforms other state-of-art CT SR frameworks (quantified by PSNR and SSIM) and achieves fine anatomical structures.

In some embodiments of present disclosure, a GAN-based framework with gradient guidance using two generative branches is provided to reconstruct the UHRCT images. In some embodiments, a GAN-based framework with gradient guidance for UHRCT reconstruction is provided. Unlike recent deep learning (DL)-based CT super-resolution methods which mainly focus on the simulated scenario, the provided framework may utilize real clinical low resolution (LR) CT images as input to predict the corresponding UHRCT.

### Gradient Guidance

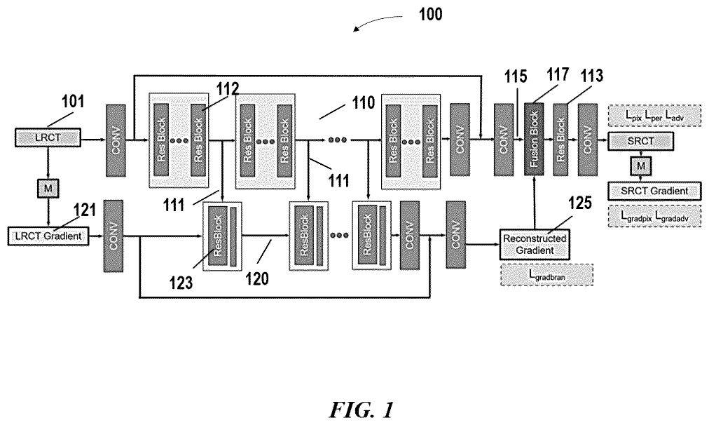

In some embodiments, the GAN-based framework may comprise a gradient guidance feature which is integrated into the two-branch network architecture and beneficially provides reliable structure recovery. Experiments on clinical and phantom dataset illustrate the model provided herein outperforms other deep learning-based methods qualitatively and quantitatively. FIG. 1 schematically illustrates the Gradient-guided GAN framework 100 for Ultra-high super-resolution CT (UHRCT).

The provided framework 100 may comprise multiple branches. In some embodiments, the framework 100 may comprise a main super resolution (SR) branch 110 configured to take low resolution CT (LRCT) 101 as inputs and generate UHRCT images. The low resolution CT 101 may be acquired under standard acquisition condition or acquired with shortened scanning time (e.g., thicker slices). The term “low resolution” CT may generally refer to a CT image with relatively lower resolution compared to the ultra-high resolution CT. The term “ultra-high resolution” CT may generally refer to CT with higher resolution that can resolve smaller anatomical structures.

In some embodiments, the framework 100 may further comprise a gradient branch 120 configured to take the gradient maps of LRCT 121 as input and guide the main branch using gradient maps of the UHRCT images that are predicted by the main branch.

In some embodiments, the gradient maps M 121 used in the framework may be the gradient intensity extracted by a convolution layer with a kernel. In some cases, the kernel may be fixed kernel. For example, the convolution layer may extract the gradient map by calculating the difference of adjacent pixels in image I:

$$M ( a ) = {‖ ( 1 ( x + 1 , y ) - 1 ( x - 1 , y ) , 1 ( x , y + 1 ) - 1 ( x , y - 1 ) ) ‖}_{2} .$$

where a=(x, y) represents the position of pixel element. According to the above equation, the gradient maps may be images depicting border structures.

In some cases, the architecture of gradient branch 120 may be a simplified version of the main branch 110. In some cases, the gradient branch may incorporate one or more feature maps 111 (intermediate feature maps) generated by the main branch to further boost the feature map information in the gradient branch. The one or more features maps 111 may be generated by the CNN layers in the main SR branch and may carry rich structural details. In some cases, the one or more feature maps 111 may be extracted after the activation layers of the corresponding residual blocks in the main branch.

In some cases, the framework of the systems herein may employ Single Image Super-resolution (SISR) methods. For example, the main SR branch 110 may apply one or more exiting single mage super resolution (SISR) building blocks to the input images. Although network architectures with more parameters tend to improve performance, a basic enhanced deep super-resolution network (EDSR) is used to demonstrate the effectiveness of the gradient guidance design and the improved performance in clinical CT super resolution tasks. As an example, the main branch model may comprise a first set of residual blocks 112 (e.g., 17 residual blocks each comprises skip connection) and the gradient branch model may comprise a second set of residual blocks 123 (e.g., 4 residual blocks). The gradient branch model may comprise fewer residual blocks than the main branch model.

The intermediate feature maps 111 from selected residual blocks of the main branch may be used to assist the generator in the gradient branch 120. In some cases, the intermediate feature maps 111 may be generated by non-consecutive residual blocks (e.g., 2nd. 6th. 10th. 14th blocks). Alternatively, the intermediate feature maps 111 may be generated by selected residual blocks that may or may not be consecutive. The residual blocks may be pre-selected. Alternatively, the residual blocks may be dynamically selected based on the property of the image, the imaged subject, a user preference, a property of the feature map (e.g., rich features in the feature map representation), an output of the model, and the like.

In some cases, after passing through the set of residual blocks of the main branch, the extracted features may be concatenated with the structure information (e.g., reconstructed gradient 125). For example, a fusion block 117 may combine (e.g., concatenate) the reconstructed gradient 125 with the feature maps 115 generated by the main branch. Then the concatenated feature maps may be used to predict the UHRCT images by using additional residual blocks (e.g., residual block 113).

### Loss Function

The training method or training framework may employ a hybrid loss function. Conventional deep learning-based SR methods may optimize the model simply by the pixel-wise loss to improve the PSNR performance aiming to reduce average pixel difference between the predicted images and the ground-truths. However, only employing pixel-wise loss can lead to over-smooth results because of the ignorance of perceptual quality. In the provided training method, a hybrid loss function comprising a combination of pixel-wise loss, perceptual loss and adversarial loss is adopted.

Pixel-wise loss: In some embodiments, the L₁ loss may be used as the pixel-wise loss:

$${L}_{pix} = {L}_{1} ( HR , SR ) = \frac{1}{N \times M} {\sum }_{i = 0}^{N - 1} {\sum }_{j = 0}^{M - 1} \vert HR ( i , j ) - SR ( i , j ) \vert$$

where N and M are width and length of the slices pairs, HR represents ground true image with high resolution, and SR represents predicted image with super resolution.

Perceptual loss: Perceptual loss and SRGAN (super-resolution using a generative adversarial network) can be used in SR tasks. The perceptual loss may be used in GAN-based SR methods where perceptual quality takes more into consideration. For example, the perceptual loss calculated the distances between feature maps extracted by a well-trained VGG-16 or VGG-19 neural network denoted as F. In the present disclosure, an ESRGAN (Enhanced super-resolution generative adversarial networks) setting is adopted where the feature maps are extracted before the activation layers. An example of the perceptual loss function is the following:

$${L}_{per} = {L}_{1} ( F ( HR ) - F ( SR ) )$$

Adversarial loss: Adversarial loss aims to assist the generator to predict more visually appealing results by optimizing it with a discriminator together. Since standard discriminator may experience hard training processes, the provided method employs the relativistic discriminator (denoted as D). The relativistic discriminator herein may not estimate the probability that one input image is real, instead it may estimate the probability that a real image is relatively more realistic than a fake one. Below is an example of the loss function:

$${L}_{dis} = - {E}_{HR} [ log ( D ( HR , SR ) ) ] - {E}_{SR} [ log ( 1 - D ( SR , HR ) ) ]$$

$${L}_{adv} = - {E}_{HR} [ log ( 1 - D ( HR , SR ) ) ] - {E}_{SR} [ log ( D ( SR , HR ) ) ]$$

Gradient loss: In some cases, gradient maps are used as side information in two ways to generate more promising structures and details. For the gradient branch component or model, the same pixel-wise loss may be used to optimize the training process. For the main branch component, a pixel-wise loss and GAN loss may be used to further restrict the SR process by imposing restrictions on the gradient map of the SR images. Below are examples of the loss function:

$${L}_{gradbran} = {L}_{1} ( M ( HR ) - {Grad}_{Recon} )$$

$${L}_{gradpix} = {L}_{1} ( M ( HR ) - M ( SR ) )$$

$${L}_{graddis} = - {E}_{M ( HR )} [ log ( D ( M ( HR ) , M ( SR ) ) ) ] - {E}_{M ( SR )} [ log ( 1 - D ( M ( SR ) , M ( HR ) ) ) ] ,$$

$${L}_{gradadv} = - {E}_{M ( HR )} [ log ( 1 - D ( M ( HR ) , M ( SR ) ) ) ] - {E}_{M ( SR )} [ log ( D ( M ( SR ) , M ( HR ) ) ] ,$$

Total loss: In some embodiments, the total loss to train the provided framework is a weighted combination of the above different losses. For example, the total loss can be defined as:

$${L}_{total} = {L}_{pix} + {α}_{1} {L}_{per} + {α}_{2} {L}_{adv} + {β}_{1} {L}_{gradpix} + {β}_{2} {L}_{gradadv} + γ {L}_{gradbran}$$

where α1, α2, β1, β2, γ are scaling factors or weights of different losses, respectively. The scaling factors or coefficients may be determined based empirical data, the performance metrics, or training results.

### Training Details

The framework herein may be trained end-to-end. The training method may use the residual blocks in enhanced deep super-resolution network (EDSR) as basic building blocks for the generator. For example, the network may comprise a plurality of basic blocks in total (e.g., 21 basic blocks), with a portion of the basic blocks in the main branch (e.g., 17 out of 21 are in the main branch). In some cases, each basic block may comprise a number of filters (e.g., 64 filters in each block). The filter may have a suitable size depending on the use application. For example, a filter size can be 3×3 or other sizes depending on the anatomical structures in the image.

### Experiments and Results

In an example of training process, the framework can be trained using the Adam optimizer with momentum of 0.9. Other training parameters may include, for example, the optimizing objectives may be pixel-wise loss, perceptual loss calculated using pre-trained VGG-19 networks, adversarial loss and combinations of gradient losses. The initial learning rates is set to 5×10⁻⁵ and is reduced to half when epoch number reaches 35. Through several contrast experiments, α1, α2, I31, I32, γ are set to 2.5, 0.05, 1, 0.05, 5 accordingly.

In some cases, a 2.5D reconstruction strategy may be used. For example, the method may take consecutive 2D coronal slices as input and summing of output accordingly. The experiments are implemented by PyTorch Library on NVIDIA RTX 2080Ti GPUs.

Dataset: With patients' approval, 43 CT pairs (24 clinical pairs and 19 phantom pairs) are collected from Hospital X. Each pair contains a low resolution CT series and a corresponding UHRCT target series obtained by secondary scanning. The clinical pairs used for subjective evaluation and the more position aligned phantom data are divided into training and testing groups. Among these data, 26 CT pairs (11 clinical pairs and 15 phantom pairs) were selected for the training process and 17 CT pairs (13 clinical pairs and 4 phantom pairs) were selected for testing phase. The voxel size of LRCT series is (0.175±0.025)×(0.175±0.025)×(0.175±0.025) mm³ and the corresponding UHRCT series is 0.69×1×0.69 mm³. The provided deep learning models aim to learn the mapping from the distribution of LRCT to the UHRCT ones.

The systems and methods herein may implement preprocessing method. In some cases, for clinical data, in order to obtain trainable pairs, preprocessing such as crop and interpolation procedure may be performed to satisfy physical space correspondence such as on the basis of the head information in DICOM files.

In some cases, although affine registration is applied to achieve better consistency between LRCT and UHRCT, physical space misalignment may be still widespread. To address this problem, the image patch pairs selection according to empirical thresholds may be implemented. For example, different PSNR and SSIM thresholds may be selected to eliminate misalignment based on different image areas (e.g., more tolerance on regions of sharp changes and more restrictions on regions within a single physiological tissue). In some cases, pixel clamping operation may be applied to remove pixel values at the edge of distribution for better generalization. The above procedures may also be applied to the phantom data, except that the registration and empirical thresholds may not be necessary due to rare risk of misalignment in phantom data.

### Evaluation Method

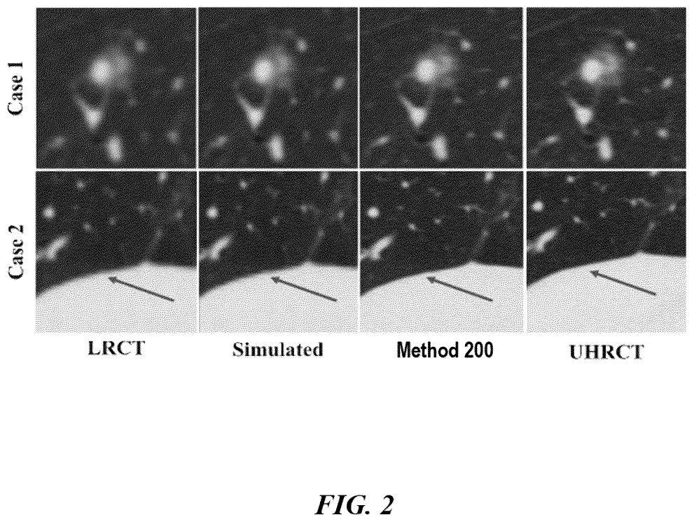

Most recent supervised studies evaluate their proprietary methods in simulated SR scenarios because simulated data pairs are easy to generate and train a good model. For example, existing evaluation method may use average slices to simulate thick-slice CT and use average pooling to get simulated LR slices. However, model achieves ideal performance target in simulated settings cannot assure they can be directly applied to real clinical data. The present disclosure provides methods to qualitatively and quantitively demonstrate the difference between simulated scenarios and practical clinical setting. In some cases, the framework may be trained on the clinical dataset mentioned above. The simulation dataset which shares the same UHRCT patches as the clinical dataset are appaired with corresponding LRCT patches generated using bilinear interpolation. The evaluation results of those models under the clinical settings are compared. FIG. 2 shows the qualitative results of the presented method 200 compared to other method/frameworks (based on simulation data). Compared with the model herein 200, the simulated model tends to generate over-smoothing structures and always leads to serrated artifacts over the sharp edges as pointed by the arrow in case 2. This is most likely due to the simulation dataset has too simple distribution to demonstrate the real degrading process in LRCT, even if it has better spatial correspondence. Quantitative results in Table. 1 illustrate the same results.

TABLE 1
Average PSNR and SSIM comparing with simulated settings.

| Method | PSNR | SSIM |
|---|---|---|
| Simulated | 31.46 | 0.870 |
| Ours | 32.84 | 0.872 |

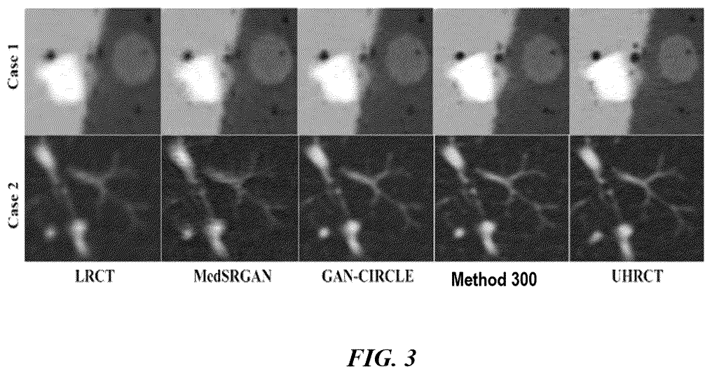

Comparison with Other Methods: Comprising the model or method herein with other method such as MedSRGAN and supervised version of GAN-CIRCLE frameworks, FIG. 3 illustrates qualitative comparison of the method with other state of the art methods. Case 1 is phantom data and Case 2 is real clinical data. As shown in FIG. 3, the framework herein 300 can better reconstruct high frequency information with reliable details on both phantom and clinical data, which is consistent with the quantitative results shown in Table. 2.

TABLE 2
Average PSNR and SSIM comparing with other methods.

| Method | PSNR | SSIM |
|---|---|---|
| MedSRGAN [6] | 31.68 | 0.841 |
| GAN-CIRCLE [3] | 32.31 | 0.863 |
| Ours | 32.84 | 0.872 |

As shown in the above examples, results from MedSRGAN suffer from severe shadowing defects. Method such as GAN-CIRCLE fails to generate images with sufficient details as our proposed method. This may be that MedSRGAN over-emphasizes on perceptual loss and neglects pixel-wise loss, which is an irreplaceable guidance in our clinical settings due to the misalignment of training data pairs, and thus result in instability of GAN losses during training. Compared to the method of using supervised version of GAN-CIRCLE without gradient guidance and unnecessary implementation of cycle consistency loss in supervised settings, the results reconstructed by GAN-CIRCLE is not as good as the presented framework.

Since medical images play a critical role in making diagnostic and treatment decisions, the content-based subjective evaluation also requires considerable attention. Results from the test dataset are evaluated by radiologists and graded on a scale from 5 (worst) to 1 (best) in terms of general image quality, general diagnostic confidence, image sharpness and image noise. Subjective evaluation results are presented in Table. 3. The method herein achieves the best grade by a large margin compared to other methods.

TABLE 3
Subjective comparison of results by different methods.

| | General | Diagnostic | | |
|---|---|---|---|---|
| Method | quality | confidence | Sharpness | De-Noise |
| Simulated | 3.64 | 3.42 | 3.28 | 3.35 |
| MedSRGAN [6] | 4.92 | 4.14 | 4.78 | 4.85 |
| GAN-CIRCLE [3] | 2.00 | 1.79 | 2.07 | 2.07 |
| Ours | 1.21 | 1.50 | 1.14 | 1.21 |

### Impact of Gradient Guidance

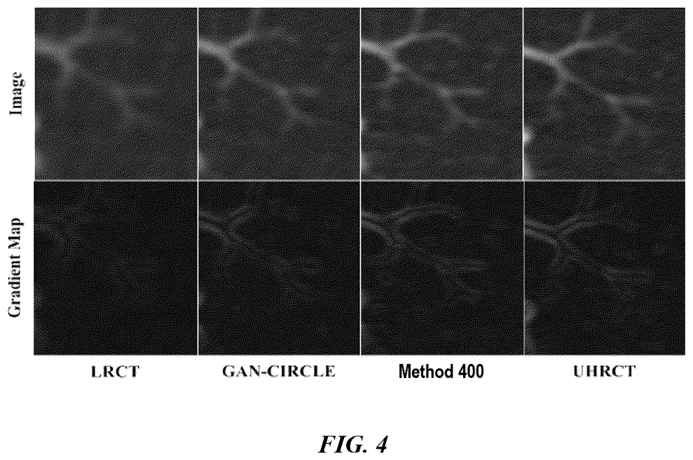

To validate the effectiveness of the gradient guidance design, FIG. 4 shows visualization of the gradient maps of different images. First row is the image and second row is its corresponding gradient map. As the visual results demonstrate, the gradient maps of UHRCT have sharper and often continuous edges. The model herein 400 successfully learns the mapping from the LR gradient maps to structure-pleasing UHRCT gradient maps while other framework still suffers from generating blurry and sometimes discontinuous edges in gradient maps, which corresponds to the unpleasant structure details in SR images.

### System Overview

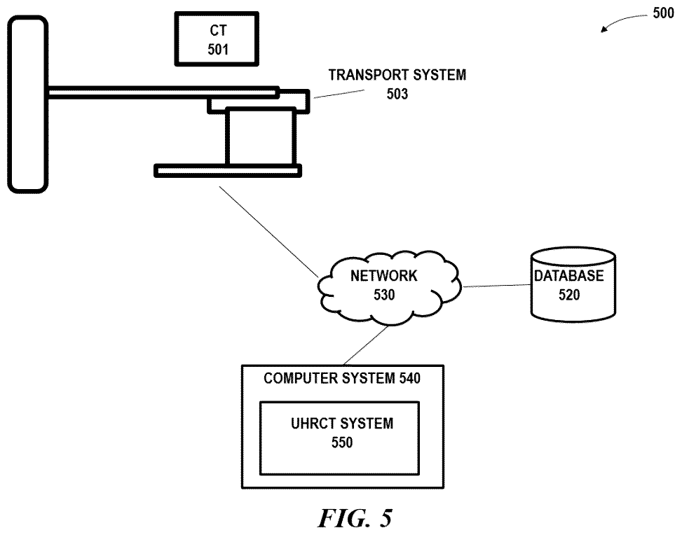

The systems and methods can be implemented on existing imaging systems such as but not limited to CT imaging system, spectral CT and various others without a need of a change of hardware infrastructure. FIG. 5 schematically illustrates an example of a system 500 comprising a computer system 540 and one or more databases operably coupled to an imaging system over the network 530. The computer system 510 may be used for further implementing the methods and systems explained above to generate an ultra-high resolution CT (UHRCT) images.

The computed tomography (CT) imaging system 501 to collect input data. The input data may be low resolution CT images. The CT image system can employ any suitable computed tomography technique such as conventional single energy CT or dual energy CT (spectral CT). The dual energy CT may utilize two separate x-ray photon energy spectra (e.g., dual source scanner), allowing the interrogation of materials that have different attenuation properties at different energies. The dual energy data (attenuation values at two energy spectra) may be used to reconstruct many different image types such as weighted average images (simulating single energy spectra), virtual monoenergetic image (attenuation at a single photon energy rather than a spectrum), material decomposition images (mapping or removing substances of known attenuation characteristics, such as iodine, calcium, or uric acid), electron density maps and the like. Based on the input image types or the input data format (e.g., dual source scanner or single source scanner), the model herein may employ corresponding first layer for processing the input. In some cases, the input image with different types may be pre-processed (e.g., concatenation of images from two sources as input) before being processed by the model.

In some embodiments, the CT imaging system 501 may comprise a controller for controlling the operation, imaging or movement of transport system 503. For example, the controller may control a CT scan based on one or more acquisition parameters set up for the CT scan.

The controller may be coupled to an operator console (not shown) which can include input devices (e.g., keyboard) and control panel and a display. For example, the controller may have input/output ports connected to a display, keyboard and or other IO devices. In some cases, the operator console may communicate through the network with a computer system that enables an operator to control the production and display of images on a screen of display. For example, images may be images with improved quality and/or accuracy acquired according to an accelerated acquisition scheme. For example, a user may set up the scan time for acquiring the CT image (with lower resolution) and/or CT image with higher resolution.

The system 500 may comprise a user interface. The user interface may be configured to receive user input and output information to a user. The user input may be related to controlling or setting up an image acquisition scheme. For example, the user input may indicate scan duration (e.g., the min/bed) for each acquisition or scan time for a frame that determines one or more acquisition parameters for an accelerated acquisition scheme. The user input may be related to the operation of the CT system (e.g., certain threshold settings for controlling program execution, image reconstruction algorithms, etc). The user interface may include a screen such as a touch screen and any other user interactive external device such as handheld controller, mouse, joystick, keyboard, trackball, touchpad, button, verbal commands, gesture-recognition, attitude sensor, thermal sensor, touch-capacitive sensors, foot switch, or any other device.

The system 500 may comprise computer systems and database systems 520, which may interact with a UHRCT system 550. The computer system may comprise a laptop computer, a desktop computer, a central server, distributed computing system, etc. The processor may be a hardware processor such as a central processing unit (CPU), a graphic processing unit (GPU), a general-purpose processing unit, which can be a single core or multi core processor, or a plurality of processors for parallel processing. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations. The imaging platform may comprise one or more databases. The one or more databases may utilize any suitable database techniques. For instance, structured query language (SQL) or “NoSQL” database may be utilized for storing image data, raw collected data, reconstructed image data, training datasets, trained model (e.g., hyper parameters), loss function, weighting coefficients, etc. Some of the databases may be implemented using various standard data-structures, such as an array, hash, (linked) list, struct, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes: they may be related to other object collections by some common attributes. Object-oriented databases perform similarly to relational databases with the exception that objects are not just pieces of data but may have other types of functionality encapsulated within a given object. If the database of the present disclosure is implemented as a data-structure, the use of the database of the present disclosure may be integrated into another component such as the component of the present disclosure. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The network 530 may establish connections among the components in the imaging platform and a connection of the imaging system to external systems. The network may comprise any combination of local area and/or wide area networks using both wireless and/or wired communication systems. For example, the network may include the Internet, as well as mobile telephone networks. In one embodiment, the network uses standard communications technologies and/or protocols. Hence, the network may include links using technologies such as Ethernet, 802.11, worldwide interoperability for microwave access (WiMAX), 2G/3G/4G/5G mobile communications protocols, asynchronous transfer mode (ATM), InfiniBand, PCI Express Advanced Switching, etc. Other networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above.

In some embodiments, UHRCT system 550 may comprise multiple components, including but not limited to, a training module, an ultra-high resolution CT inference module, and a user interface module.

The training module may be configured to train a model using the deep learning model framework as described above. The training module may train the model to predict a CT image with higher resolution compared to the input low-resolution CT image. The higher resolution CT image may allow users to visualize fine or detailed anatomic structures. The training module may be configured to obtain and manage training datasets. For example, the training datasets for may comprise pairs of high resolution and low resolution CT images acquired by CT scanners as described above. The training module may be configured to train a deep learning network for enhancing the image resolution as described elsewhere herein. The training module may be configured to implement the deep learning methods as described elsewhere herein. The training module may train a model off-line. Alternatively or additionally, the training module may use real-time data as feedback to refine the model for improvement or continual training.

The UHRCT inference module may be configured to enhance the CT image quality or resolution using a trained model obtained from the training module. The UHRCT inference module may implement the trained model for making inferences, i.e., outputting CT images with resolution improved over the input CT image.

The user interface (UI) module may be configured to provide a UI to receive user input related to the ROI and/or user preferred output result. For instance, a user may be permitted to, via the UI, set acquisition parameters (e.g., acquisition time) or identify regions of interest (ROI) in the lower resolution images to be enhanced. The UI may display the improved SPECT image.

Methods and systems of the present disclosure can be implemented by way of one or more algorithms. An algorithm can be implemented by way of software upon execution by the central processing unit.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for ultra-high resolution computed tomography comprising:
(a) acquiring, using computed tomography (CT), a medical image of a subject, wherein the medical image has a lower resolution; and
(b) processing the medical image, with aid of a deep learning network model, to reconstruct an ultra-high resolution medical image, wherein the deep learning network model is trained using a generative adversarial network (GAN)-based framework with a gradient guidance.

2. The computer-implemented method of claim 1, wherein the GAN-based framework comprises a first branch for improving a resolution of a medical image, and a second branch for generating a predicted gradient map.

3. The computer-implemented method of claim 2, wherein the predicted gradient map is used to guide the training of the first branch.

4. The computer-implemented method of claim 3, wherein the predicted gradient map is concatenated with a feature map of the first branch and is supplied to a residual block.

5. The computer-implemented method of claim 2, wherein the second branch uses a pixel-wise loss in a training process.

6. The computer-implemented method of claim 2, wherein the first branch uses a combination of pixel-wise loss and a GAN loss in a training process.

7. The computer-implemented method of claim 2, wherein the second branch incorporates one or more intermediate feature maps generated by the first branch.

8. The computer-implemented method of claim 7, wherein the first branch comprises a set of residual blocks and the one or more intermediate feature maps are generated by one or more residual blocks selected from the set of residual blocks.

9. The computer-implemented method of claim 2, wherein the first branch comprises a first set of residual blocks and wherein the second branch comprises a second set of residual blocks.

10. The computer-implemented method of claim 2, where an input to the second branch includes a gradient map of the medical image acquired in (a).

11. The computer-implemented method of claim 1, wherein the deep learning network model is trained using a loss function comprising a combination of at least pixel-wise loss, adversarial loss, and perceptual loss.

12. A non-transitory computer-readable storage medium including instructions that, when executed by one or more processors, cause the one or more processors to perform operations comprising:
(a) acquiring, using computed tomography (CT), a medical image of a subject, wherein the medical image has a lower resolution; and
(b) processing the medical image, with aid of a deep learning network model, to reconstruct an ultra-high resolution medical image, wherein the deep learning network model is trained using a generative adversarial network (GAN)-based framework with a gradient guidance.

13. The non-transitory computer-readable storage medium of claim 12, wherein the GAN-based framework comprises a first branch for improving a resolution of a medical image, and a second branch for generating a predicted gradient map.

14. The non-transitory computer-readable storage medium of claim 13, wherein the predicted gradient map is used to guide the training of the first branch.

15. The non-transitory computer-readable storage medium of claim 14, wherein the predicted gradient map is concatenated with a feature map of the first branch and is supplied to a residual block.

16. The non-transitory computer-readable storage medium of claim 13, wherein the second branch uses a pixel-wise loss in a training process.

17. The non-transitory computer-readable storage medium of claim 13, wherein the first branch uses a combination of pixel-wise loss and a GAN loss in a training process.

18. The non-transitory computer-readable storage medium of claim 13, wherein the second branch incorporates one or more intermediate feature maps generated by the first branch.

19. The non-transitory computer-readable storage medium of claim 18, wherein the first branch comprises a set of residual blocks and the one or more intermediate feature maps are generated by one or more residual blocks selected from the set of residual blocks.

20. The non-transitory computer-readable storage medium of claim 13, wherein the first branch comprises a first set of residual blocks and wherein the second branch comprises a second set of residual blocks.
